(19) United States
(12) Patent Application Publication
(10) Pub. No.: US 2013/0233209 A1
(43) Pub. Date: Sep. 12, 2013

(54) Furniture Assembly System and Method

(71) Applicants: Brett Stenhouse, Phoenix, AZ (US); Thad Trubakoff, Tempe, AZ (US); Zachary I. Eyman, Scottsdale, AZ (US); Michael Patrick Murphy, Scottsdale, AZ (US)

(72) Inventors: Brett Stenhouse, Phoenix, AZ (US); Thad Trubakoff, Tempe, AZ (US); Zachary I. Eyman, Scottsdale, AZ (US); Michael Patrick Murphy, Scottsdale, AZ (US)

(73) Assignee: ERGOTRON, INC., St. Paul, MN (US)

(21) Appl. No.: 13/600,376

(22) Filed: Aug. 31, 2012

Related U.S. Application Data
(60) Provisional application No. 61/529,547, filed on Aug. 31, 2011.

(51) Int. Cl. A47B 13/00; F16M 11/04

(52) U.S. Cl. CPC A47B 13/003; F16M 11/041
USPC 108/59; 403/22; 29/428

(57) ABSTRACT

A furniture assembly system and method useful for assembling furniture provided in disassembled pieces. The system and method can securely and permanently connect two or more pieces of furniture with a furniture element connector without the use of separate tools. The furniture element connector can remain with the furniture while the furniture is in use.

### RELATED APPLICATIONS

This application claims the benefit of U.S. Provisional Application Ser. No. 61/529,547, titled Furniture Assembly System and Method, filed Aug. 31, 2011, the contents of which are hereby incorporated by reference.

### FIELD

The invention generally relates to systems and methods for assembling furniture.

### BACKGROUND

Furniture is frequently sold as a disassembled set of pieces or elements for assembly by a customer. Generally, such furniture is packaged along with fasteners, such as screws, bolts, and nuts, which are used to connect the various pieces together. These fasteners are actuated by the customer with separate tools, such as screwdrivers and wrenches. Unfortunately, many customers may not have these tools, or the correct sizes and configurations of these tools, immediately at hand when attempting to assemble the furniture.

### SUMMARY

Embodiments of the invention include a furniture assembly system and method useful for assembling furniture provided in disassembled pieces. In some embodiments, the system and method can securely and permanently connect two or more pieces of furniture without the use of any separate tools. Embodiments of the invention include furniture, such as desks, tables, stands, shelving assemblies, and the like, assembled with the system, and the methods of assembly themselves.

### BRIEF DESCRIPTION OF THE DRAWINGS

The following drawings are illustrative of particular embodiments of the present invention and therefore do not limit the scope of the invention. The drawings are not to scale (unless so stated) and are intended for use in conjunction with the explanations in the following detailed description. Embodiments of the present invention will hereinafter be described in conjunction with the appended drawings, wherein like numerals denote like elements.

FIG. 1 includes a side plan view with a cut-away portion of assembled furniture in accordance with an embodiment of the invention.

FIG. 2 includes a perspective disassembled view of furniture elements in accordance with an embodiment of the invention.

FIG. 3 includes a perspective assembled view of the furniture elements of FIG. 2.

FIG. 4 includes a side plan view of a furniture element connector depicted in first and second positions in accordance with an embodiment of the invention.

FIG. 5 includes a front plan view of the furniture element connector of FIG. 4.

### DETAILED DESCRIPTION OF THE PREFERRED EMBODIMENTS

The following detailed description is exemplary in nature and is not intended to limit the scope, applicability, or configuration of the invention in any way. Rather, the following description provides some practical illustrations for implementing exemplary embodiments of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

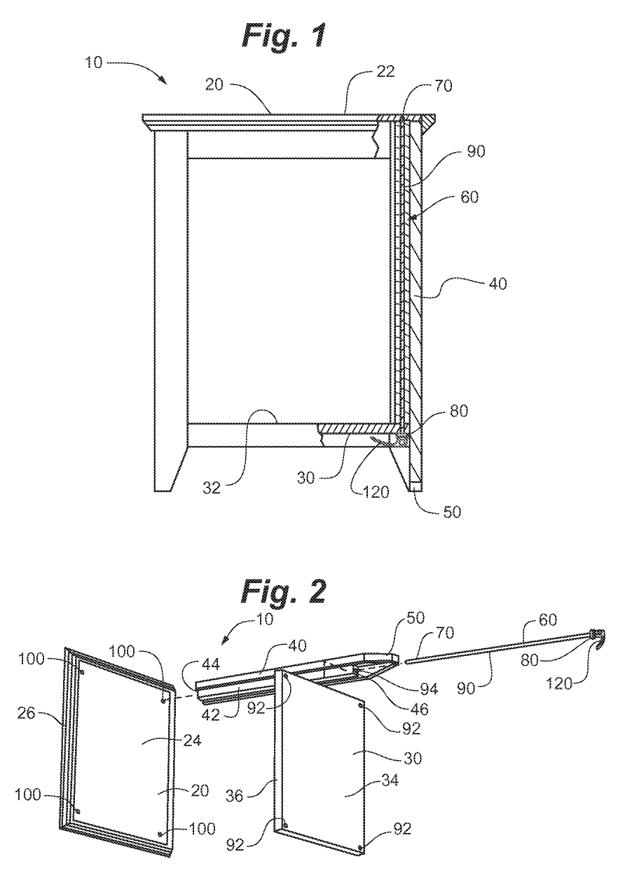

Embodiments of the invention include assembled furniture, such as a desk, table, stand, shelving assembly, or the like. In some embodiments, as shown in FIGS. 1-3, the furniture 10 includes a first furniture element 20 and a second furniture element 30. The first and second furniture elements can be generally planar and each include a front surface 22 and 32, respectively, defining a front plane, a back surface 24 and 34, respectively, defining a back plane, a perimeter 26 and 36, respectively, defining a perimeter plane generally perpendicular to the front and back planes, and a thickness (which may be different or equal). In some embodiments, the front surface 22 of the first furniture element can be a generally horizontal work surface when the furniture elements are assembled and the furniture is properly positioned for use. As shown, the second furniture element can be spaced from and parallel to the first furniture element.

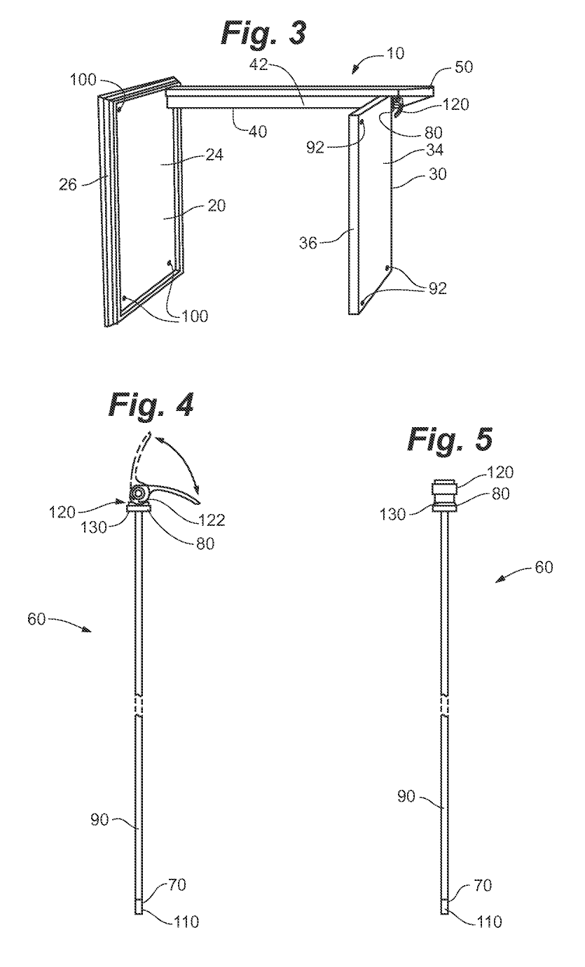

In some embodiments, the furniture includes an elongate furniture element 40 in apposition with the first furniture element 20 and the second furniture element 30. The elongate furniture element is useful for positioning the first and second furniture elements at a predetermined distance from each other, as it can include a compression portion 42 that will be in compression between the first and second furniture elements when the furniture is assembled. In some embodiments, the compression portion has a first surface 44 generally parallel to and in apposition to the back surface 24 of the first furniture element and a second surface 46 parallel to and in apposition to the front surface 32 of the second furniture element 30. In some embodiments, the elongate furniture element is a “leg” of furniture. Further, it can also include a foot portion 50 extending beyond (e.g., beneath) the first or second furniture elements when assembled, as shown in FIGS. 1 and 3.

Embodiments of the invention also include a furniture element connector 60 useful for permanently and rigidly connecting the first and second furniture elements. An exemplary embodiment of such a furniture element connector is shown in FIGS. 4-5. As used herein, “permanent” means the furniture element connector is not removed before the furniture is placed into service, and does not mean the furniture cannot be disassembled when desired. In some embodiments, the furniture element connector extends between the first furniture element and the second furniture element to provide the rigid connection.

As shown best in FIG. 1, the furniture element connector 60 can have a first end 70 rigidly connected to either the first furniture element 20 or the second furniture element 30. As shown, the first end can be rigidly connected proximate the back surface 24 of the first furniture element 20. The furniture element connector 60 can also have a second end 80 in compressive engagement with the other of the first furniture element 20 or the second furniture element 30. As shown, the second end can be in compressive engagement with the back surface 34 of the second furniture element 30. In some embodiments, the furniture element connector has an elongate shaft 90 (e.g., having a longitudinal axis and a generally circular cross-section) extending through an aperture 92 defined in second furniture element 30 and an aperture 94 defined by the elongate furniture element 40 and extending through the compression portion 42 and between the first and second furniture elements. In certain embodiments, the first end 70 of the furniture element connector includes a threaded portion 110 that is received within a threaded portion of an aperture 100 defined by the first or second furniture element to form the rigid connection.

On a second end 80 opposite the first end 70, the furniture element connector 60 can include a pivoting lever 120 pivotably connected to the elongate shaft 90 (e.g., via a hinge). The pivoting lever 120 can include a cam member 122 with an eccentric shape. FIG. 4 depicts movement of the pivoting lever 120 and cam member between an open, upward position and a closed, downward position. In such embodiments, the cam member provides the compressive engagement a furniture element, optionally via a washer as described below. The pivoting lever can also act like a handle with a turn radius greater than the radius of the elongate shaft to rotate the elongate shaft to threadingly engage it with the furniture element. In some embodiments, the compression portion 42 of the elongate furniture member has a length generally corresponding to the length of the elongate shaft 90 such that the first and second furniture elements are compressed against it when the cam is pivoted to a closed position.

Accordingly, in some embodiments, after assembly, from the bottom up, the furniture will include lever 120, cam member 122 acting against the back surface 34 of second furniture element 30, shaft 90 will extend through aperture 92 in second furniture element 30 through the aperture 94 extending through compression portion 42 of elongate furniture element 40, and threaded portion 110 of shaft 90 will be threadingly received within a threaded portion of an aperture 100 defined by back surface 24 of the first furniture element 20.

Note that FIG. 1 shows only one side in cut away such that only one furniture element connector is depicted. However, it should be noted that in some embodiments furniture 10 can include two, three, or four furniture element connectors and associated two, three, or four elongate furniture elements. In some embodiments, furniture 10 includes first, second, third, and fourth furniture element connectors and associated first, second, third, and fourth elongate furniture elements respectively placed proximate the perimeters of the first and second furniture elements (e.g., one each proximate each corner in embodiments having generally rectangular first and second furniture elements). FIGS. 2 and 3 identify additional apertures 92 and 100 to further illustrate exemplary positions of additional furniture element connectors. In such embodiments, all the furniture elements included within the furniture may be assembled with only the furniture element connectors, such that separate tools are not required to assemble the furniture elements.

In some embodiments, the furniture does not include the second furniture element 30. In such embodiments the cam member 122 acts against the second surface 46 of compression portion 42.

The furniture element connector 60 can also include a washer 130 that receives the elongate shaft 90 and is movable along a longitudinal axis of the elongate shaft. As shown, the washer is in contact with the eccentric shape and is moved along the elongate shaft as the cam member is pivoted with respect to the elongate shaft. The washer is useful for spreading the compressive forces provided by the cam over a larger area on the furniture element, such as back surface 34 of the second furniture element 30.

As noted above, in some embodiments the elongate furniture element 40 can include a foot portion 50 extending beyond the portion of the elongate furniture element that is compressed between the first and second furniture elements (e.g., beneath the back surface 34 of the second furniture element when assembled). Such a foot portion is useful for shielding the pivoting lever 120 and cam member 122. In other embodiments, the foot portion is not integral with the elongate furniture element, but is rather attached to it or the second furniture element to shield the pivoting lever 120 and cam member 122.

The various furniture elements and the furniture element connector can include any desirable materials. In some embodiments, the furniture elements include wood and/or press board and the furniture element connector includes metal.

The invention also includes methods of assembling furniture. In some embodiments, the method includes the step of rigidly connecting a first end of a furniture element connector to a first furniture element. The method can also include the step of positioning a second furniture element or a surface of a compression portion in a desired position spaced from the first furniture element. In some embodiments, the method includes the steps of applying compressive force to the second furniture element or surface of a compression portion with the second end of the furniture element connector (e.g., via a cam member).

In certain embodiments, the elongate shaft is inserted through an aperture defined by an elongate furniture element separating the first and second furniture elements. A threaded end of the elongate shaft is threadingly connected with a threaded portion provided by one of the furniture elements. In some embodiments, the pivoting lever can be used as a handle to provide the rotational force. When snug, the cam member provided by the pivoting lever can be pivoted with respect to the elongate shaft to provide a compressive force on a furniture element, optionally through a washer positioned between the cam member and the furniture element. This process can be repeated as necessary (e.g., three more times) until the furniture is fully assembled. The furniture connecting elements are not removed before the furniture is placed into service, such that they become part of the furniture after it is assembled. In such embodiments, a customer is able to rigidly and permanently assemble furniture without the use of separate tools.

Thus, embodiments of the invention are disclosed. Although the present invention has been described in considerable detail with reference to certain disclosed embodiments, the disclosed embodiments are presented for purposes of illustration and not limitation and other embodiments of the invention are possible. One skilled in the art will appreciate that various changes, adaptations, and modifications may be made without departing from the spirit of the invention and the scope of the appended claims.

What is claimed is:

1. Assembled furniture, comprising:
a first furniture element;
a second furniture element spaced from the first furniture element;
an elongate furniture element in apposition with the first furniture element and the second furniture element; and
a furniture element connector extending between the first furniture element and the second furniture element, the furniture element connector having a first end rigidly connected to either the first furniture element or the second furniture element and a second end in compressive engagement with the other of the first furniture element or the second furniture element.

2. The assembled furniture of claim 1, wherein the first and second furniture elements are planar and spaced parallel to each other.

3. The assembled furniture of claim 1, wherein the furniture element connector has an elongate shaft received within an aperture defined by the elongate furniture element.

4. The assembled furniture of claim 1, wherein the first end of the furniture element connector includes a threaded portion that is received within a threaded portion of the first or second furniture element to form the rigid connection.

5. The assembled furniture of claim 1, wherein the furniture element connector includes a pivoting lever with a cam member pivotably connected to an elongate shaft, the cam member providing the compressive engagement with the first or second furniture element.

6. A method of assembling furniture, the method comprising the steps of:
rigidly connecting a first end of a furniture element connector to a first furniture element;
positioning a second furniture element in a desired position spaced from the first furniture element by an elongate furniture element; and
applying compressive force to the second furniture element with the second end of the furniture element connector.

7. The method of claim 6, wherein the first and second furniture elements are planar and spaced parallel to each other.

8. The method of claim 6, wherein the furniture element connector has an elongate shaft received within an aperture defined by the elongate furniture element in apposition with the first and second furniture elements.

9. The method of claim 6, wherein the first end of the furniture element connector includes a threaded portion that is received within a threaded portion of the first furniture element to form the rigid connection.

10. The method of claim 6, wherein the furniture element connector includes a pivoting lever with a cam member pivotably connected to the elongate shaft, the cam member providing the compressive engagement with the second furniture element.

11. Assembled furniture, comprising:
a first furniture element;
an elongate furniture element having a compression portion and a first surface in apposition with the first furniture element and a second surface; and
a furniture element connector extending between the first furniture element and the second surface, the furniture element connector having a first end rigidly connected to the first furniture element and a second end in compressive engagement with the second surface.

12. The assembled furniture of claim 11, wherein the first furniture element is planar and parallel to the second surface.

13. The assembled furniture of claim 11, wherein the furniture element connector has an elongate shaft received within an aperture defined by the elongate furniture element.

14. The assembled furniture of claim 11, wherein the first end of the furniture element connector includes a threaded portion that is received within a threaded portion of the first furniture element to form the rigid connection.

15. The assembled furniture of claim 11, wherein the furniture element connector includes a pivoting lever with a cam member pivotably connected to an elongate shaft, the cam member providing the compressive engagement with the second surface.
